(19) United States
(12) Patent Application Publication
(10) Pub. No.: US 2011/0294922 A1
(43) Pub. Date: Dec. 1, 2011

(54) ENCAPSULATION OF PHOSPHORUS PENTASULFIDE

(75) Inventors: Anthony J. KRIECH, Indianapolis, IN (US); Timothy P. REECE, Indianapolis, IN (US); Herbert L. WISSEL, Indianapolis, IN (US)

(73) Assignee: HERITAGE ENVIRONMENTAL SERVICES LLC, Indianapolis, IN (US)

(21) Appl. No.: 13/115,414

(22) Filed: May 25, 2011

Related U.S. Application Data
(60) Provisional application No. 61/349,429, filed on May 28, 2010.

(51) Int. Cl. C04B 24/26; C04B 16/00

(52) U.S. Cl. 524/2; 106/823; 106/807

(57) ABSTRACT

A method of treating or encapsulating phosphorus pentasulfide so that it can be safely handled, stored and transported. The treating or encapsulating involves combining the phosphorus pentasulfide with a hydrocarbon oil under high shearing conditions. The hydrocarbon oil can be a mineral oil such as a paraffinic oil. The encapsulated phosphorus pentasulfide is pumpable and, according to one embodiment, is used as a modifier/crosslinking agent in asphalt mixtures.

### RELATED APPLICATION

This application is based upon U.S. Provisional Application Ser. No. 61/349,426, filed May 28, 2010 to which priority is claimed under 35 U.S.C. §120, and of which the entire disclosure is hereby expressly incorporated by reference.

### BACKGROUND

The present invention relates generally to the handling, storage and use of phosphorus pentasulfide. In particular the present invention relates to treating phosphorus pentasulfide so that it can be safely handled, stored and transported. More particularly the present invention relates to encapsulating phosphorus pentasulfide so that it can be safely handled, stored and transported.

Phosphorus pentasulfide (also known as: diphosphorus pentasulfide, phosphorus sulfide, phosphorus persulfide, etc.) is a highly reactive inorganic compound with molecular formula of P₂S₅ or P₄S₁₀ or P₄S₉. Phosphorus pentasulfide is commercially the most important sulfide of phosphorus and one of the most reactive towards moisture and water. Upon contact with moisture phosphorus pentasulfide will immediately release hydrogen sulfide and will react violently with water to form thiophosphoric acid intermediates and eventually hydrophosphoric acid. The release of hydrogen sulfide is a primary health hazard with phosphorus pentasulfide and therefore phosphorus pentasulfide requires special handling and transportation for safety purposes.

In addition to being violently reactive with water, airborne dust of phosphorus pentasulfide is irritating to lungs, eyes, nose, throat and skin.

Handling recommendations for industrial processes that involve the use of phosphorus pentasulfide include total enclosure with a low moisture inert atmosphere, maintaining a low humidity atmosphere in work areas where containers are opened and product is transferred to processes, and avoiding sliding or rough handling of containers.

Since the dry powders can build static electricity when subjected to the friction of conveying, mixing or sliding care must be taken when using phosphorus pentasulfide in industrial processes.

Phosphorus pentasulfide must be stored in cool, dry ventilated storage areas. In case of spills, evacuation of personal is required.

The present invention provides a manner of treating phosphorus pentasulfide so that it can be safely handled, stored and transported.

### BRIEF SUMMARY

According to various features, characteristics and embodiments of the present invention which will become apparent as the description thereof proceeds, the present invention provides a method of treating phosphorus pentasulfide which comprises:

providing a quantity of phosphorus pentasulfide;

combining the phosphorus pentasulfide with a high viscosity, low volatility, and low water solubility hydrocarbon oil to form a mixture of phosphorus pentasulfide and the hydrocarbon oil; and

subjecting the mixture of the phosphorus pentasulfide and hydrocarbon oil to shearing to encapsulate and reduce the particle size of the phosphorus pentasulfide in the hydrocarbon oil.

The present invention further provides an encapsulated phosphorus pentasulfide product which comprises particles of phosphorus pentasulfide that are encapsulated in hydrocarbon oil.

The present invention further provides a modified asphalt that includes the encapsulated phosphorus pentasulfide.

### DETAILED DESCRIPTION OF THE DRAWINGS AND THE PRESENTLY PREFERRED EMBODIMENTS

The present invention is directed to treating phosphorus pentasulfide so that it can be safely handled, stored and transported. More particularly the present invention relates to encapsulating phosphorus pentasulfide so that it can be safely handled, stored and transported. The encapsulation of the phosphorus pentasulfide according to the present invention provides an immediate inert environment that isolates the phosphorus pentasulfide from ambient environments, including environments that can include humidity and/or moisture.

In order to create the immediate inert environment that isolates the phosphorus pentasulfide, the phosphorus pentasulfide has to be in a dry particulate form. As will be discussed below, phosphorus pentasulfide can be treated or encapsulated as a dry powder according to the present invention and thereafter further processed to have a smaller particle size or sized prior to encapsulation. According to one embodiment treated or encapsulated phosphorus pentasulfide is formed into a pumpable consistency.

According to the present invention the phosphorus pentasulfide is treated or encapsulated with an oil that has a high flash point (above about 200° C.) and which is non-reactive with phosphorus pentasulfide. The viscosity of the oil preferably ranges at 60-225 cSt at 40° C., 9-15 cSt at 100° C., 325-1225 SUS at 100° F. and 55-80 SUS at 210° F. Hydrocarbon oils such as mineral oils, including paraffinic and naphthenic oils have been found to be particularly suitable for purposes of the present invention.

The phosphorus pentasulfide is treated or encapsulated by combining a dry powder form of phosphorus pentasulfide with the hydrocarbon oil under high shearing conditions to ensure that substantially all the particles of phosphorus pentasulfide will be coated with the hydrocarbon oil. This mixing is conducted under a dry inert atmosphere to prevent reaction of the phosphorus pentasulfide with any ambient humidity or moisture. The phosphorus pentasulfide and hydrocarbon oil can be feed into a high shear mill simultaneously and the mixing can be done at room temperature.

According to one embodiment the particle size of the dry phosphorus pentasulfide is reduced by grinding or milling, for example using a ball mill, to a size that is suitable for purposes of pumping the final treated phosphorus pentasulfide. For example, the particle size can be reduced so that about 80% of the particles of phosphorus pentasulfide pass through a 100 mesh screen. During the course of the present invention it was determined that a particle size of 50 microns or less would ensure that the phosphorus pentasulfide would form a suspension with desired stability. It is also possible to mill the particles in a colloidal mill after combining the phosphorus pentasulfide particles with the hydrocarbon oil. The particles of the phosphorus pentasulfide should be sized so that they form a stable colloidal system in the hydrocarbon oil with little or no settling. The resulting stable colloidal system can be safely stored, transported or used in industrial processes.

According to one embodiment of the present invention the treated or encapsulated phosphorus pentasulfide is used as an asphalt modifier/crosslinking agent in a polymer modified asphalt. In this embodiment, the ratio of the phosphorus pentasulfide to the hydrocarbon oil can range from about 2:1 to about 1:1.

When incorporated into a polymer modified asphalt as described in the example below, the treated or encapsulated phosphorus pentasulfide and polymer can be added to an asphalt simultaneously or separately in any order. Suitable polymers include styrene butadiene styrene block copolymer and can be present in the polymer modified asphalt at about 1.5 to about 6.5 wt. %. The amount of encapsulated phosphorus pentasulfide in the polymer modified asphalt can be from about 0.4 to 1 wt. % when the ratio of phosphorus pentasulfide to mineral oils is 1:1 and from about 0.2-0.6 when the ratio of phosphorus pentasulfide to mineral oils is 2:1.

Making the treated or encapsulated phosphorus pentasulfide pumpable enables it to be easily used in commercial industrial processes. It is further pourable which can be convenient.

Features and characteristics of the present invention will be demonstrated in the following non-limiting example.

### EXAMPLE

In this Example encapsulated phosphorus pentasulfide is produced according to the present invention.

100 grams of paraffinic mineral oil having a viscosity of 180 cSt. at 40° C. was placed in a container and 200 grams of phosphorus pentasulfide added to the oil. The mixture was then sheared with a Silverson high shear mixer for 2 minutes. The resulting suspension was tested for reactivity with water. No release of hydrogen sulfide was detected. The resulting mixture was a pumpable suspension at ambient temperatures.

Also in this example treated or encapsulated phosphorus pentasulfide produced according to the present invention was used as an asphalt modifier/crosslinking agent in a polymer modified asphalt.

Asphalt binder compositions were prepared by employing the following method. To a quart can container was added 500 grams of asphalt binder preheated to 163° C. The asphalt binder was obtained from BP (Whiting, Ind.) and had a PG rating of 64-22 per AASHTO M320. Using a quart can heater, the asphalt binder was heated to 190° C. and sheared with a Silverson high shear mixer at which time phosphorus pentasulfide and the unsaturated polymer (polymer ID: LCY 3411) were introduced by direct addition. Shearing of the sample within the container continued for 30 minutes. A lid was loosely placed on the container and the container was placed in an oven set at 163° C. for 18 hours. Upon the removal of the container from the oven and removal of the lid, any skim layer present was removed. The sample was then stirred and poured through a 20 mesh screen and the screened material was used for preparing the test samples.

The amount and the form of the phosphorus pentasulfide added to each sample is set forth in Table 1. A portion of each sample was taken and prepared into various test specimens as required for each standardized test employed. The test methods employed throughout these examples are provided in Table 1. The amounts of the polymer and P2S5 are provided in Table 1 in parts by weight per 100 parts by weight asphalt.

TABLE 1

| | | Sample # | | |
|---|---|---|---|---|
| | Test Method | 1 | 2 | 3 |
| Polymer | | 1.5 | 1.5 | 1.5 |
| Total % of P₂S₅ in the | | 0.5 | 0.5 | 0.5 |
| final product | | | | |
| Parts P₂S₅ to Parts Mineral | | 2 to 1 | 1 to 1 | |
| Oil Slurry | | | | |
| Original Fail Temp, ° C. | AASHTO T315 | 77.9 | 78.7 | 79.2 |
| Phase Angle at 76° C. | AASHTO T315 | 69.7 | 70.7 | 67.7 |
| RTFO Fail Temp, ° C. | AASHTO | 77.0 | 77.2 | 78.7 |
| | T240/T315 | | | |
| RTFO Elastic Recovery | AASHTO T301 | 85.0 | 84.5 | 87.0 |
| @25° C., % | | | | |
| Separation ° F. | ASTM D-7173 | 0.5 | 2 | 0.5 |
| Softening Point, ° F. | AASHTO T53 | 154.5 | 147.5 | 159 |

In samples 1 and 2 the polymer was sheared into the asphalt for 20 minutes and the slurry of P₂S₅ and Mineral Oil (treated or encapsulated phosphorus pentasulfide) was next sheared into the asphalt for 10 minutes. These 2 samples cured overnight for 18 hours in a 325° F. oven before testing began.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

1. A method of treating phosphorus pentasulfide which comprises:
providing a quantity of phosphorus pentasulfide;
combining the phosphorus pentasulfide with a hydrocarbon oil to form a mixture of phosphorus pentasulfide and the hydrocarbon oil; and
subjecting the mixture of the phosphorus pentasulfide and hydrocarbon oil to shearing to encapsulate the phosphorus pentasulfide with the hydrocarbon oil.

2. A method of treating phosphorus pentasulfide according to claim 1, wherein the hydrocarbon oil comprises a mineral oil.

3. A method of treating phosphorus pentasulfide according to claim 2, wherein the hydrocarbon oil comprises a paraffin oil.

4. A method of treating phosphorus pentasulfide according to claim 1, wherein the hydrocarbon oil has a viscosity of about 60-225 CST at 40° C. and about 9-15 at 100° C.

5. A method of treating phosphorus pentasulfide according to claim 1, wherein the phosphorus pentasulfide has a particle size of 50 micron or less.

6. A method of treating phosphorus pentasulfide according to claim 1, wherein the ratio of the phosphorus pentasulfide to the hydrocarbon oil is from about 2:1 to about 1:1.

7. A method of treating phosphorus pentasulfide according to claim 1 wherein the encapsulated phosphorous pentasulfide comprises a pumpable material.

8. An asphalt modifier/crosslinking agent which comprises the encapsulated phosphorus pentasulfide of claim 1.

9. An asphalt that comprises the encapsulated phosphorus pentasulfide of claim 1.

10. An asphalt according to claim 9, wherein the asphalt further comprises a polymer.

11. An asphalt according to claim 10, wherein the polymer is an unsaturated polymer.

12. An encapsulated phosphorus pentasulfide product which comprises particles of phosphorus pentasulfide that are encapsulated in a hydrocarbon oil.

13. An encapsulated phosphorus pentasulfide product according to claim 12, wherein the encapsulated phosphorus pentasulfide is pumpable.

14. An encapsulated phosphorus pentasulfide product according to claim 12, wherein the ratio of the phosphorus pentasulfide to the hydrocarbon oil is from about 2:1 to about 1:1.

15. An encapsulated phosphorus pentasulfide product according to claim 12, wherein the hydrocarbon oil comprises mineral oil.

16. An encapsulated phosphorus pentasulfide product according to claim 12, wherein the hydrocarbon oil comprises paraffinic oil.

17. An encapsulated phosphorus pentasulfide product according to claim 12, wherein the phosphorus pentasulfide has a particle size or 50 microns or less.

18. A method of producing a modified asphalt which comprises combining the encapsulated phosphorus pentasulfide of claim 12 into an asphalt mixture.

19. A method of producing a modified asphalt according to claim 18, further comprising adding a polymer to the asphalt mixture.

20. A method of producing a modified asphalt according to claim 19, wherein the encapsulated phosphorus pentasulfide and polymer are added into the asphalt simultaneously together or separately in any order.
